(19) United States
(12) Patent Application Publication
(10) Pub. No.: US 2012/0309615 A1
(43) Pub. Date: Dec. 6, 2012

(54) PLATINUM MONOLAYER ON ALLOY NANOPARTICLES WITH HIGH SURFACE AREAS AND METHODS OF MAKING

(75) Inventors: Minhua Shao, Farmington, CT (US); Belabbes Merzougui, Dhahran (SA); Lesia V. Protsailo, Bolton, CT (US)

(73) Assignee: UTC POWER CORPORATION, South Windsor, CT (US)

(21) Appl. No.: 13/578,043

(22) PCT Filed: Feb. 12, 2010
(86) PCT No.: PCT/US2010/000414

§ 371 Date: Aug. 9, 2012

(51) Int. Cl. B01J 25/00

(52) U.S. Cl. 502/301

(57) ABSTRACT

A catalytic nanoparticle includes a porous core and an atomically thin layer of platinum atoms on the core. The core is a porous palladium, palladium-M or platinum-M core, where M is selected from the group consisting of gold, iridium, osmium, palladium, rhenium, rhodium and ruthenium.

### BACKGROUND

Platinum or platinum alloy nanoparticles are well known for use as an electrocatalyst, particularly in fuel cells used to produce electrical energy. For example, in a hydrogen fuel cell, a platinum catalyst is used to oxidize hydrogen gas into protons and electrons at the anode of the fuel cell. At the cathode of the fuel cell, the platinum catalyst triggers the oxygen reduction reaction (ORR), leading to formation of water.

Although platinum is a preferred material for use as a catalyst in a fuel cell, platinum is expensive. Moreover, the fuel cell performance is dependent on the available surface area of the platinum nanoparticles. Fuel cell performance increases when the surface area of platinum nanoparticles is increased by increasing the loading of platinum. However, increasing platinum loading typically also increases the cost of materials.

### SUMMARY

A catalytic nanoparticle includes a porous core and a monolayer of platinum atoms on the core. The core may be a porous palladium, palladium-M or platinum-M core, where M is selected from the group consisting of gold, iridium, osmium, palladium, rhenium, rhodium and ruthenium.

### BRIEF DESCRIPTION OF THE DRAWINGS

FIG. 1 is a schematic of a fuel cell that uses the catalytic nanoparticles described herein.

FIG. 2 is a schematic diagram of a catalytic nanoparticle having a porous core.

FIG. 3 is a method of forming the catalytic nanoparticle of FIG. 2 with a palladium-copper alloy nanoparticle.

FIG. 4 plots cyclic voltammograms of PdCu₆ alloy nanoparticles initially and after 50 cycles.

FIG. 5 plots normalized mass activity of carbon supported platinum particles and a platinum monolayer on carbon supported porous cores formed from PdCu₆ alloy nanoparticles.

FIG. 6 is a transmission electron microscopy (TEM) image of a platinum monolayer on porous cores formed from PdCu₆ alloy nanoparticles.

FIG. 7 is another method of forming the catalytic nanoparticle of FIG. 2 with a palladium-transition metal-copper alloy nanoparticle.

FIG. 8 is a further method of forming the catalytic nanoparticle of FIG. 2 with a palladium-platinum-copper alloy nanoparticle.

FIG. 9 is a block diagram of a still further method of forming the catalytic nanoparticle of FIG. 2 with a platinum-noble metal-copper alloy nanoparticle.

### DETAILED DESCRIPTION

Catalytic nanoparticles having porous cores and monolayer of platinum atoms are described herein. These nanoparticles can be used in fuel cells and other electrochemical devices.

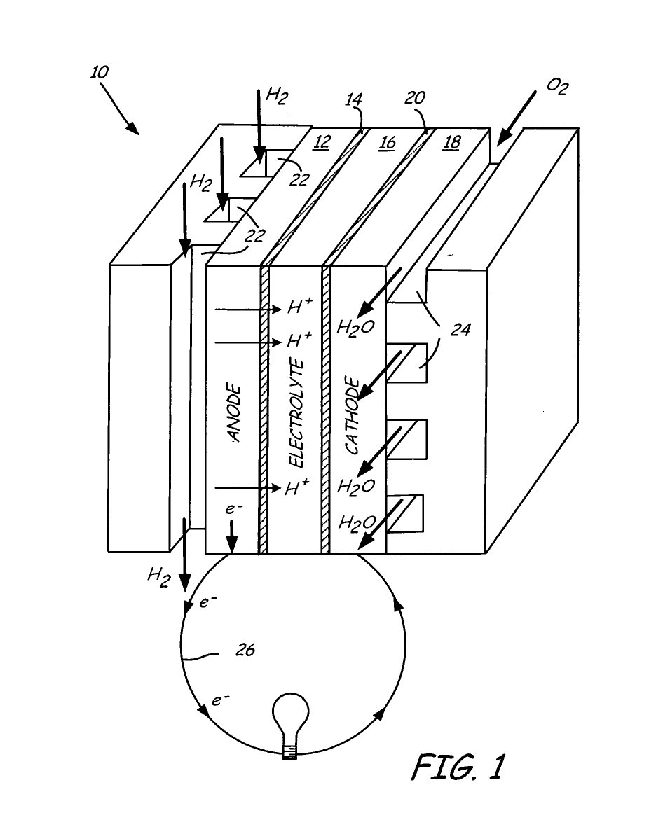

FIG. 1 is one example fuel cell 10, designed for generating electrical energy, that includes anode gas diffusion layer (GDL) 12, anode catalyst layer 14, electrolyte 16, cathode gas diffusion layer (GDL) 18, and cathode catalyst layer 20. Anode GDL 12 faces anode flow field 22 and cathode 18 GDL faces cathode flow field 24. In one example, fuel cell 10 is a fuel cell using hydrogen as fuel and oxygen as oxidant. It is recognized that other types of fuels and oxidants may be used in fuel cell 10.

Anode GDL 12 receives hydrogen gas (H₂) by way of anode flow field 22. Catalyst layer 14, which may be a platinum catalyst, causes the hydrogen molecules to split into protons (H⁺) and electrons (e⁻). While electrolyte 16 allows the protons to pass through to cathode 18, the electrons travel through an external circuit 26, resulting in a production of electrical power. Air or pure oxygen (O₂) is supplied to cathode 18 through cathode flow field 24. At cathode catalyst layer 20, oxygen molecules react with the protons from anode catalyst layer 14 to form water (H₂O), which then exits fuel cell 10, along with excess heat.

Electrolyte 16 varies depending on the particular type of fuel cell. In one example, fuel cell 10 is a polymer electrolyte membrane (PEM) fuel cell, in which case electrolyte 16 is a proton exchange membrane formed from a solid polymer. In another example, fuel cell 10 is a phosphoric acid fuel cell, and electrolyte 16 is liquid phosphoric acid, which is typically held within a ceramic (electrically insulating) matrix.

Platinum particles can form the basis of anode catalyst layer 14 and cathode catalyst layer 20. The platinum particles are typically dispersed and stabilized on catalyst support structures and/or on carbon. The platinum is used to increase the rate of the oxygen reduction reaction (ORR) in the fuel cell.

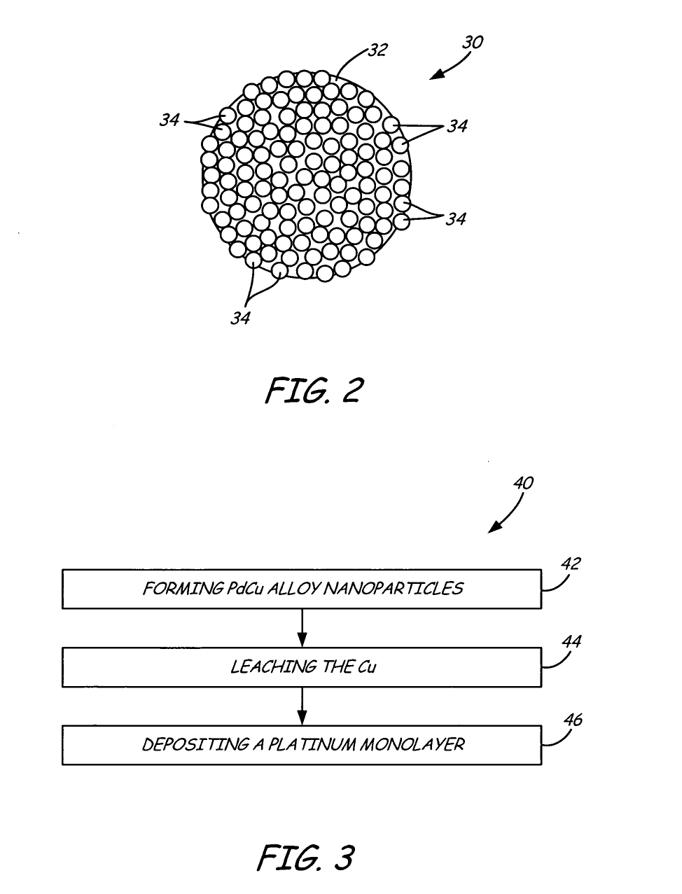

FIG. 2 schematically represents catalytic nanoparticle 30 having porous core 32 and platinum atoms 34. Catalytic nanoparticle 30 has a core-shell structure. Platinum 34 forms an atomically thin layer on core 32. Platinum atoms can, for example, form a monolayer, a bilayer or a trilayer on core 32. In one example, core 32 is between about 2 nanometers (nm) and about 50 nm in diameter.

Core 32 is porous or is full of pores. In one example, core 32 has pores between about 0.5 nanometers (nm) and about 5.0 nm. In another example, core 32 has pores between about 0.5 nm about 1.0 nm. The porous structure of core 32 provides an increased surface area for platinum 34, which improves the platinum mass activity. The porous structure of core 32 also allows oxygen molecules to more easily diffuse through porous core 32. This porous core structure improves the oxygen reduction reaction kinetics when catalytic nanoparticles 30 are used in, for example, a fuel cell.

Core 32 can include palladium, a palladium-noble metal alloy or a platinum-noble metal alloy where the noble metal is selected from gold, palladium, iridium, rhenium, rhodium, ruthenium and osmium. Catalytic nanoparticles 30 can reduce the overall catalyst cost. Catalytic nanoparticles are expensive to produce because of the high cost of noble metals, particularly the high cost of platinum. The core-shell structure of catalytic nanoparticles 30 reduces costs because the high cost platinum is limited to the surface of catalytic nanoparticles 30 while core 32 is formed from less expensive palladium or palladium-M. Thus, platinum is present only where it is utilized for the reactions of the fuel cell. Additionally, the porous structure of core 32 reduces the noble metal loading of catalytic nanoparticles 30.

A palladium core alone is not stable in a fuel cell environment. Palladium is more reactive than platinum and will dissolve at a less positive potential. Depositing a shell of platinum 34 on core 32 improves the durability of core 32. It has been found that catalytic nanoparticles 30 have durability similar to that of solid pure platinum nanoparticles.

Core 32 may not have the same lattice structure and/or electronic structure as the bulk metal of which it is formed. For example, when core 32 is formed of palladium, the lattice structure and electronic structure of core 32 is smaller than that of bulk palladium. The lattice structure and electronic structure of the material of core 32 are altered during the production of core 32.

As described further below, porous core 32 can be formed by leaching copper from palladium-copper alloy or platinum-noble metal-copper alloy nanoparticles. The starting alloy nanoparticles have a noble metal to non-noble metal mole ratio of about 1:1 to about 1:12 in one example and about 1:4 to about 1:8 in another example. In some situations, the copper may not be completely removed such that core 32 includes trace amounts of copper and core 32 is an alloy. Transition metal M or platinum can also be included in the palladium-copper alloy nanoparticles.

FIG. 3 is a block diagram illustrating method 40 for forming catalytic nanoparticles 30 of FIG. 2 from palladium-copper alloy nanoparticles. Method 40 includes forming palladium-copper alloy nanoparticles (step 42), leaching the copper (step 44) and depositing a platinum monolayer (step 46). The copper is leached from the alloy nanoparticles to create porous cores 32 of FIG. 2. Leaching the copper before the platinum monolayer is deposited reduces the trace amount of copper remaining in the structure and so reduces the risk of membrane, ionomer and/or anode poisoning when catalytic nanoparticles 30 are used in a fuel cell.

In step 42, palladium-copper alloy nanoparticles are formed. In one example, palladium-copper alloy nanoparticles are formed by physically mixing carbon supported palladium nanoparticles with a solution containing copper salts, such as copper II nitrate (Cu(NO₃)₂)). The dried mixture is heated at a temperature between about 400 degrees Celsius and about 1000 degrees Celsius to anneal the nanoparticles and form palladium-copper alloy nanoparticles. In one example, the nanoparticles are annealed for a period between about 30 minutes and about 8 hours. In another example, the nanoparticles are annealed for a period between about 2 hours and about 4 hours.

The palladium-copper alloy nanoparticles are formed by a plurality of copper atoms interspersed with palladium atoms. The palladium-copper alloy nanoparticles are solid nanoparticles having, for example, a diameter between about 2 nm and about 50 nm.

The amount of copper II nitrate and palladium mixed to form the nanoparticles is controlled to control the copper to palladium mole ratio of the resulting alloy nanoparticles. In one example, the copper to palladium mole ratio of the alloy nanoparticles is between about 2:1 to about 12:1, and the atomic ratio of copper to palladium is larger than about 2. In another example, the copper to palladium mole ratio is between about 4:1 and about 8:1. One skilled in the art will recognize that other techniques can be used to form palladium-copper alloy nanoparticles. For example, palladium salts and copper salts can be mixed in solution and co-reduced by a reducing agent, such as sodium borohydride, to form the alloy nanoparticles. Regardless of the method used, the copper to palladium mole ratio of the starting alloy nanoparticles is maintained between about 2:1 and about 12:1.

The copper is leached from the palladium-copper alloy nanoparticles in step 44. Leaching the copper from the palladium-copper alloy nanoparticles creates porous cores 32. In one example, copper is leached from the palladium-copper alloy nanoparticles with an acid solution, such as a nitric acid (HNO₃) solution. The temperature and concentration of the acid solution is controlled to promote the dissolution of copper while preventing the dissolution of palladium. For example, the concentration of nitric acid can be in the range of about 1 M to about 3 M, and the temperature of the dissolution process can be between about 20 degrees Celsius and about 60 degrees Celsius. In another example, copper is leached from the palladium-copper alloy nanoparticles by an electrochemical method. In one example, copper is leached from the palladium-copper alloy nanoparticles by potential cycling in a potential range of 0.02-1.2 V vs. RHE in 0.1 M HClO₄ at a scan rate of 0.05 V/s and a temperature of 25° C. The dissolved copper can be recovered and reused to further reduce the cost of materials.

Pores are formed when copper atoms are removed from the alloy nanoparticle and palladium atoms relocate by atomic diffusion. The resulting porous palladium core 32 has nanometer-sized pores. In one example, the palladium core has pores between about 0.5 nm and about 5.0 nm. In another example, the pores are between about 0.5 nm and about 1.0 nm. The size of the pores can be adjusted by changing the mole ratio of copper to palladium in the starting palladium-copper alloy nanoparticles. Increasing the ratio of copper in the alloy nanoparticles increases the size of pores formed when the copper is leached from the nanoparticles. As described above, the copper to palladium mole ratio of the alloy nanoparticles can be maintained between about 2:1 to about 12:1.

In step 46, a platinum monolayer is deposited on the porous palladium cores. This step includes depositing copper on the porous palladium core by underpotential deposition, and replacing or displacing the copper with platinum to form catalytic nanoparticles 30 of FIG. 2.

Underpotential deposition is an electrochemical process that results in the deposition of one or two monolayers of a metal (copper) onto the surface of another metal (palladium) at a potential positive of the thermodynamic potential for the reaction. Thermodynamically, underpotential deposition occurs because the work function of copper is lower than that of the palladium nanoparticles.

The copper is deposited as a continuous or semi-continuous monolayer of copper atoms on the porous palladium cores. The copper monolayer can contain pinholes where gaps or spaces exist in the layer. In one example, porous palladium cores deposited on an electrically conductive substrate were placed in a solution consisting of 0.05 M CuSO₄+0.05 M H₂SO₄ saturated with argon and the potential was controlled at 0.1 V (vs. Ag/AgCl, 3M) for 5 minutes resulting in the underpotential deposition of copper on the porous palladium cores.

Next, platinum is deposited on the porous palladium core by displacing the copper atoms to form catalytic nanoparticles 30 of FIG. 2. Through an oxidation reduction reaction, platinum atoms displace the copper atoms on the porous palladium core. For example, the palladium cores can be mixed with an aqueous solution containing a platinum salt. In a specific example, the platinum solution is 2 mM PtK₂Cl₄+0.05 M H₂SO₄ saturated with argon. Platinum ions of the solution are spontaneous reduced by copper as shown in equation (1), and platinum replaces copper on the porous palladium core.

Cu+Pt²⁺→Pt+Cu²⁺ (1)

The platinum atoms are deposited as an atomically thin layer on the palladium core. In one example, the atomically thin layer is a platinum monolayer. The platinum monolayer generally covers the palladium core. However, some portions of the palladium core may not be covered. Repeating step 46, including the under potential deposition of copper atoms and displacing the copper with platinum, results in the deposition of additional platinum layers on core 32. For example, a bilayer or a trilayer of platinum atoms can be formed on core 32.

In method 40, copper is removed from the palladium-copper alloy before platinum is deposited. It should be noted that a small amount of residual copper may remain in the nanoparticles after the leaching step. For example, leaching can remove 85% or more of the copper initially present in the alloy nanoparticles. Thus, porous core 32 can comprise copper equal to or less than about 15% of the copper initially present in the alloy nanoparticles. This small amount of copper will not have a large impact on the performance or durability of the fuel cell. Particularly, the residual copper will not have a large impact because the copper which could not be removed during the production of catalytic nanoparticles 30 also will not leach out during the potential cycling of a fuel cell. In contrast, if the copper is not removed from the nanoparticle core before the platinum monolayer is deposited, the copper will leach out of the cores during use of the nanoparticles in a fuel cell. The dissolved copper will lower the performance and durability of the fuel cell due to membrane, ionomer and/or anode poisoning. Additionally, if the copper is not leached out prior to the platinum deposition, the core-shell structure of catalytic nanoparticles 30 will collapse during use in a fuel cell due to dissolution of the copper.

Removing copper from the palladium-copper alloy nanoparticles prior to depositing the platinum monolayer creates a porous palladium core. As described above, the porosity of core 32 improves diffusion of oxygen molecules and the oxygen reduction reaction kinetics.

The ratio of palladium to copper in the palladium-copper alloy nanoparticles affects the porosity of the nanoparticles. For example, a lower palladium to copper ratio generally results in a higher porosity core. The porosity affects how easily the oxygen molecules diffuse in the palladium core and likely contributes to the increased platinum mass activity of catalytic nanoparticles 30. As described above, in one example the atomic ratio of copper to palladium should be at least about 2.

Catalytic activity of nanoparticles 30 benefits from the lattice support effect and electronic effect achieved by using an alloy core which is more stable than an unalloyed core. In addition, the alloyed core stability reduces the risk of membrane, ionomer and/or anode poisoning by copper. A core material has a large effect on the mass activity of a platinum catalyst because of the structural and electronic effect of the core material. Palladium-copper alloys have a lattice constant and electronic properties that are different than those of bulk palladium. Core 32 formed from a palladium-copper alloy nanoparticle has a lattice constant smaller than that of palladium and platinum. The lattice constant and electronic properties of platinum are changed by core 32 and are different than that of bulk platinum. The ratio of palladium to copper in the palladium copper alloy nanoparticles can be adjusted to tailor the structural and electronic effects of the core.

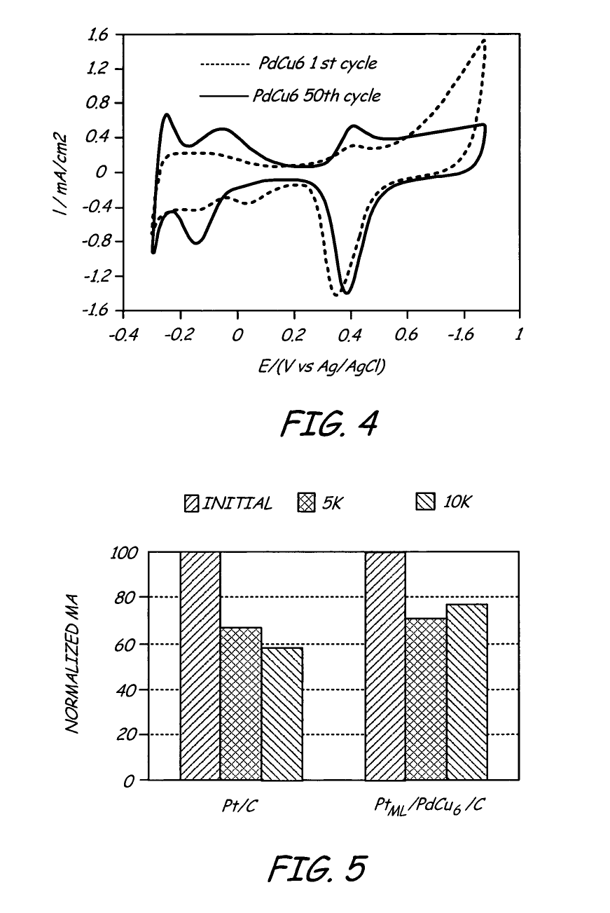

As discussed above, copper can be leached from the palladium-copper alloy nanoparticles using an electrochemical process. FIG. 4 represents cyclic voltammograms (CV) during potential cycling in 0.1 M HClO₄ at a scan rate of 0.1 V/s and a temperature of 25° C. The first plot is a CV of the initial PdCu₆ alloy nanoparticles (labeled PdCu₆ 1^{st} cycle in FIG. 4). PdCu₆ 1^{st} cycle represents the alloy nanoparticles before copper is removed. The surface of the PdCu₆ alloy nanoparticles consists of palladium and copper atoms as illustrated by the high currents at potentials higher than 0.6 volts. The second plot is a CV of the PdCu₆ alloy nanoparticles after 50 cycles (labeled PdCu₆ 50^{th} cycle in FIG. 4). After 50 cycles, the copper has been sufficiently removed from the alloy nanoparticles as illustrated by the flat line at potentials higher than 0.6 volts. The profile of PdCu₆ 50^{th} cycle is similar to that of pure palladium.

Catalytic nanoparticles 30 having a platinum monolayer on porous palladium cores have a higher platinum mass activity than carbon supported platinum particles. Table 1 presents the annealing temperature (in degrees Celsius) and the platinum mass activity (in ampere (A) per milligram platinum (mg, Pt) for several different catalysts.

TABLE 1
Platinum Mass Activity of Platinum and Pt/Pd Catalysts

| | Annealing Temp. | Pt Mass Activity |
|---|---|---|
| Catalyst | (° C.) | (A/mg, Pt) |
| Pt/C(standard) | N/A | 0.2 |
| Pt_{ML}/Pd/C | N/A | 0.67 |
| Pt_{ML}/PdCu₆/C | 700 | 2.5 |
| Pt_{ML}/PdCu₆/C | 400 | 1.3 |
| Pt_{ML}/PdCu₃/C | 700 | 1.7 |

The catalysts include carbon supported platinum atoms (Pt/C(standard)), a platinum monolayer on carbon supported palladium nanoparticles (Pt_{ML}/Pd/C) and a platinum monolayer on carbon supported palladium alloy nanoparticles formed according to method 40 (Pt_{ML}/PdCu₆/C, Pt_{ML}/PdCu₃/C). The catalysts formed from palladium alloy nanoparticles had a higher mass activity than the other catalysts.

The platinum mass activity differs due to the electronic effect and the structural effect the palladium alloy has on the platinum. The lattice constant of a palladium alloy is smaller than that of bulk palladium, and the lattice constant of the porous palladium core after the copper leaching process is also smaller than bulk palladium. The lattice constant of the platinum monolayer changes to match the lattice constant of the core when deposited thereon. Thus, platinum monolayer of Pt_{ML}/PdCu₆/C has a smaller lattice constant than that of Pt_{ML}/Pd/C.

Additionally, a palladium alloy has a different electronic effect on platinum layers than a bulk palladium has. The different electronic effect of the palladium alloy changes the degree of activity enhancement on platinum.

Further, the porous structure of Pt_{ML}/PdCu₆/C may be contributing to the increased mass activity compared to Pt_{ML}/Pd/C and Pt/C. The porous structure of Pt_{ML}/PdCu₆/C allows oxygen molecules to easily diffuse in the nanoparticles and improves the oxygen reduction reaction kinetics.

The effect of the anneal temperature is seen by comparing Pt_{ML}/PdCu₆/C annealed at 400 degrees Celsius with Pt_{ML}/PdCu₆/C annealed at 700 degrees Celsius. The alloy annealed at 400 degrees Celsius has a mass activity of 1.3 A/mg,Pt, while the alloy annealed at 700 degrees Celsius has a mass activity of 2.5 A/mg,Pt. The lower annealing temperature resulted in a low alloy degree and a lower mass activity.

FIG. 5 illustrates the durability of catalytic nanoparticles 30. FIG. 5 plots the normalized mass activity of carbon supported platinum particles (labeled Pt/C) and carbon supported catalytic nanoparticles 30 having porous palladium cores formed from PdCu₆ alloy nanoparticles and a platinum monolayer (labeled Pt_{ML}/PdCu₆/C), initially, at 5,000 cycles and at 10,000 cycles. The electrodes were subjected to potential cycling in 0.1 M HClO₄ between the potential limits of 0.65 V and 1.0 V vs. RHE. The normalized mass activity changes as a function of the number of cycles. As illustrated in FIG. 5, Pt_{ML}/PdCu₆/C nanoparticles have a similar durability compared to platinum supported platinum (Pt/C).

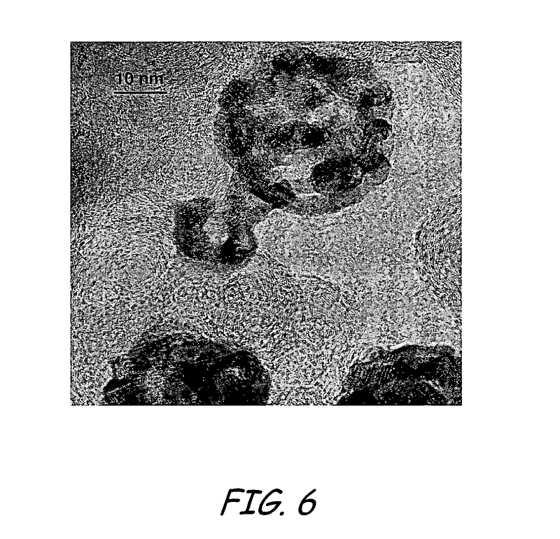

FIG. 6 is a transmission electron microscopy (TEM) image of nanoparticles formed according to method 40 and having platinum monolayers on porous palladium cores. The cores of FIG. 6 were formed from PdCu₆ alloy nanoparticles. The color variation illustrates the porosity of the nanoparticles. The darker colors illustrate metal parts and the lighter colors illustrate pores in the nanoparticle. As shown, the palladium cores are porous. This porosity enables the oxygen molecules to easily diffuse in the porous palladium cores and improves the oxygen reduction reaction kinetics.

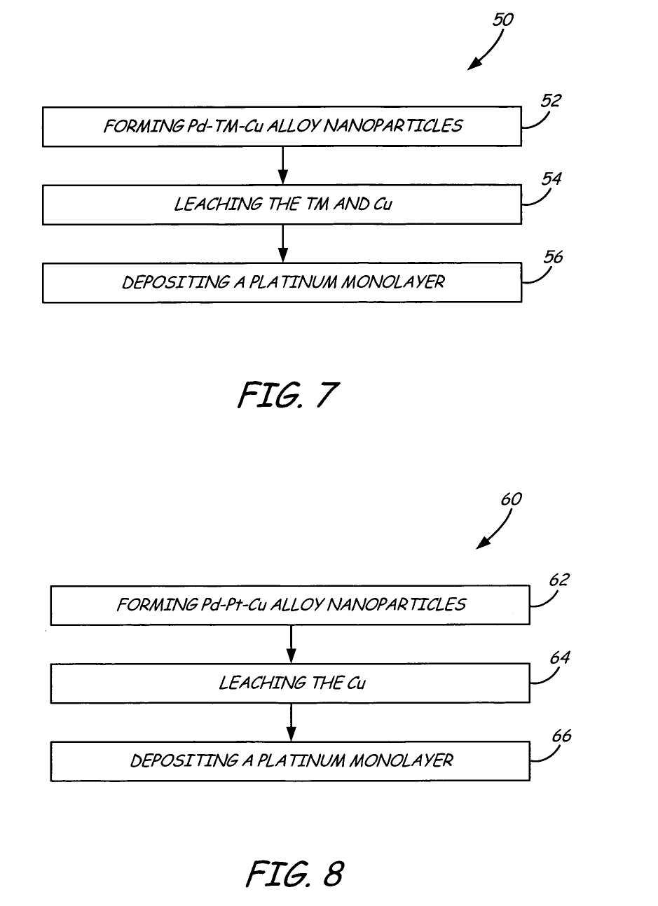

FIG. 7 illustrates an alternative method 50 of forming porous catalytic nanoparticles 30. Method 50 includes forming palladium-transition metal-copper (Pd-TM-Cu) alloy nanoparticles, where TM is a transition metal, (step 52), leaching the copper and transition metal (step 54) and depositing a platinum monolayer (step 56). In method 40 of FIG. 3, porous cores 32 are formed from palladium-copper alloy nanoparticles. In method 50, the palladium-copper alloy nanoparticles contain an additional transition metal, where the transition metal is a non-noble metal. For example, nickel, cobalt, iron, chrome, zinc and molybdenum are transitions metals that can be added to the alloy nanoparticles. The Pd-TM-Cu alloy nanoparticles can be formed using alloying processes similar to those described for step 42 of FIG. 3. For example, Pd-TM-Cu alloy nanoparticles can be formed by mixing carbon supported palladium nanoparticles with a solution containing salts of copper and salts of a transition metal, and heat treating the nanoparticles. In one example, the Pd-TM-Cu alloy nanoparticles have diameters between about 5 nm and about 50 nm. The Pd-TM-Cu alloy nanoparticles are solid nanoparticles comprised of palladium, transition metal and copper atoms interspersed with one another. As described further below, the transition metal allows core 32 to be further tailored. The noble metal to non-noble metal mole ratio of the Pd-TM-Cu nanoparticles is between about 1:1 and about 1:12 in one example and about 1:4 and about 1:8 in another example, where palladium is the noble metal and the transition metal and copper are the non-noble metals.

In step 54, the transition metal and copper are removed or leached from the alloy nanoparticles to create porous cores 32 of FIG. 2. Leaching the transition metal and copper create pores in the palladium core. In one example, the pores have a size between about 0.5 nm and about 5.0 nm. In another example, the pores have a size between about 0.5 nm and about 1.0 nm.

A leaching process similar to those described above with respect to step 44 of FIG. 3 can be used to remove the transition metal and the copper from the Pd-TM-Cu alloy nanoparticles. The conditions of the leaching process should be controlled to prevent the dissolution of palladium. For example, the transition metal and the copper can be leached from the alloy nanoparticles using a 1 M to 3 M nitric acid solution and a temperature of 20 degrees Celsius to 60 degrees Celsius. Alternatively, the transition metal and copper can be leached using an electrochemical process such as potential cycling in a potential range of about 0.02 V to about 1.2 V vs. RHE in 0.1 M HClO₄ at a scan rate of 0.05 V/s and a temperature of 25 degrees Celsius.

The leaching process will remove the transition metal and the copper from the alloy nanoparticle leaving a porous palladium core. In some situations, the leaching process may not be able to remove all of the transition metal and the copper from the alloy nanoparticles such that the porous core is an alloy containing palladium, copper and the transition metal.

In step 56, platinum is deposited on porous core 32 using a process described above with respect to step 46 of FIG. 3. Step 56 includes depositing copper on the porous palladium core and displacing the copper with platinum to form an atomically thin layer of platinum atoms on the palladium core. Deposition of the platinum atoms on the porous core creates catalytic nanoparticle 30 of FIG. 2. Additional layers of platinum can be deposited on the palladium core by repeating step 56.

Method 50 enables an additional transition metal to be added to the alloy nanoparticles. As described above, porous core 32 formed from a palladium alloy has a different structural and electronic effect on platinum 24 than a pure palladium core. Adding the additional transition metal to the alloy nanoparticle allows additional tailoring of the structural and electronic effect of core 32 to improve the platinum mass activity of catalytic nanoparticles 30.

The mole ratios of palladium, copper and the transition metal of the alloy nanoparticles are adjusted to control the porosity of core 32. For example, increasing the mole ratio of either copper or the transition metal to palladium increases the porosity. In one example, the mole ratio of copper and transition metal to palladium (i.e. the non-noble metal to noble metal mole ratio) is between about 1:1 and about 1:12. In another example, the mole ratio of copper and transition metal to palladium is between about 1:4 and about 1:8. In a further example, the atomic ratio of copper and the transition metal to palladium is larger than about 2.

FIG. 8 is a block diagram illustrating a further method of forming catalytic nanoparticles 30 in which core 32 contains palladium and a small amount of platinum. Method 60 includes forming palladium-platinum-copper (Pd—Pt—Cu) alloy nanoparticles (step 62), leaching the copper (step 64) and depositing a platinum monolayer (step 66). In step 62, alloy nanoparticles containing palladium, copper and platinum are formed. The nanoparticles can be formed using a process similar to that described above with respect to step 42 of FIG. 3. In one example, carbon supported Pd—Pt alloy nanoparticles are mixed with a solution containing copper salt and dried to form Pd—Pt—Cu alloy nanoparticles. In another example, carbon supported nanoparticles are mixed with a solution of platinum and copper salts and dried. In a further example, carbon supported platinum nanoparticles are mixed with a solution of palladium and copper salts and dried.

The platinum to palladium ratio can be adjusted so that the alloy contains a small amount of platinum compared to palladium in order to reduce the material costs. In one example, the platinum to palladium mole ratio is about 1:2 to about 1:12. In another example, the platinum to palladium mole ratio is between about 1:3 and about 1:6. Example Pd—Pt—Cu alloys include Pd₄PtCu₂₄ and Pd₄PtCu₁₅. As described below, adding platinum to the starting alloy nanoparticles improves the durability of core 32.

The copper to palladium mole ratio of the alloy nanoparticles is also controlled to control the porosity of the resulting porous cores. In one example, the copper to palladium mole ratio is between about 2:1 to 12:1. In another example, the copper to palladium mole ratio is between about 4:1 to about 8:1.

Steps 64 and 66 are the same as steps 44 and 46 of FIG. 3. In step 64, copper is leached from the Pd—Pt—Cu alloy nanoparticles to form porous core 32 of FIG. 2 containing a palladium-platinum alloy. The reaction conditions are controlled to promote the dissolution of copper while preventing the dissolution of palladium and platinum. In one example, copper is dissolved using a nitric acid solution. For example, the palladium-platinum-copper alloy nanoparticles are mixed with a 1 M to 3 M nitric acid solution at a temperature between about 20 degrees Celsius and about 60 degrees Celsius. In another example, the copper is dissolved using an electrochemical process, such as by potential cycling in the potential range of about 0.02 V to about 1.2 V vs. RHE in a 0.1 M HClO₄ solution.

In step 66, a monolayer of platinum is deposited on the porous palladium-platinum alloy core. Step 66 can include the underpotential deposition of copper and displacing copper with platinum. Depositing the platinum monolayer creates catalytic nanoparticle 30 of FIG. 2. Additional layers of platinum can be formed by repeating step 66.

Adding platinum to the starting alloy nanoparticles increases the durability of catalytic nanoparticles 30. As discussed above, platinum monolayer 34 may not completely cover core 32. Small gaps or spaces, known as pinholes, can exist between platinum atoms. Palladium is more active than platinum and will dissolve at a lower potential. Adding platinum to porous core 32 enhances the stability of core 32 and reduces the risk of palladium dissolution.

Additionally, the platinum of the Pd—Pt—Cu alloy nanoparticles can be replaced with another noble metal so that the starting alloy nanoparticles are Pd-M-Cu nanoparticles, where M represents a noble metal selected from gold, palladium, iridium, rhodium, rhenium, ruthenium and osmium. The Pd-M-Cu nanoparticles are formed according the method described above and the resulting catalytic nanoparticles have a porous Pd-M core with a monolayer of platinum atoms deposited thereon.

Methods 40, 50 and 60 presented above illustrate methods of forming catalytic nanoparticles having platinum monolayers supported on porous cores formed from palladium alloy nanoparticles. The activities of the catalytic nanoparticles are affected by many factors including the palladium alloy and the annealing temperature (as discussed above). Table 2 presents the annealing temperature (degrees Celsius) and the platinum mass activity (ampere (A)/milligram platinum (mg, Pt)) for several catalyst structures having palladium cores, palladium-copper alloy cores and palladium-platinum-copper alloy cores.

TABLE 2
Platinum Mass Activity of Various Catalysts

| | Annealing Temp. | Pt Mass Activity |
|---|---|---|
| Catalyst | (° C.) | (A/mg, Pt) |
| Pt/C(standard) | N/A | 0.2 |
| Pt_{ML}/Pd/C | N/A | 0.67 |
| Pt_{ML}/PdCu₆/C | 700 | 2.5 |
| Pt_{ML}/PdCu₆/C | 400 | 1.3 |
| Pt_{ML}/PdCu₃/C | 700 | 1.7 |
| Pt_{ML}/Pd₄PtCu₂₄/C | 700 | 0.73 |
| Pt_{ML}/Pd₄PtCu₁₅/C | 700 | 0.62 |

Pt/C (standard) are carbon supported platinum particles and Pt_{ML}/Pd/C are platinum monolayers on carbon supported palladium particles. Pt_{ML}/PdCu₆/C and Pt_{ML}/PdCu₃/C are platinum monolayers deposited on carbon supported palladium-copper alloy (PdCu₆ and PdCu₃, respectively) nanoparticles according to method 40 described above. Pt_{ML}/Pd₄PtCu₂₄/C and Pt_{ML}/Pd₄PtCu₁₅/C are platinum monolayers deposited on carbon supported palladium-platinum-copper alloys according to method 60 described above. Catalysts formed from palladium-copper alloy and palladium-platinum-copper alloy nanoparticles resulted in a larger platinum mass activity than the standard Pt/C. Additionally, each palladium-copper alloy and palladium-platinum-copper alloy catalyst except one had a larger platinum mass activity than Pt_{ML}/Pd/C.

For example, Pt_{ML}/Pd/C and Pt_{ML}/PdCu₆/C annealed at 700 degrees Celsius can be compared. Pt_{ML}/Pd/C has a mass activity of 0.67 A/mg Pt and Pt_{mL}/PdCu₆/C has a mass activity of 2.5 A/mg Pt. The platinum mass activity differs due to the electronic effect and the structural effect the palladium alloy has on the platinum. Further, the porous structure of Pt_{ML}/PdCu₆/C may be contributing to the increased mass activity. The porous structure of PM_{L}/PdCu₆/C allows oxygen molecules to easily diffuse in the nanoparticles and improves the oxygen reduction reaction kinetics.

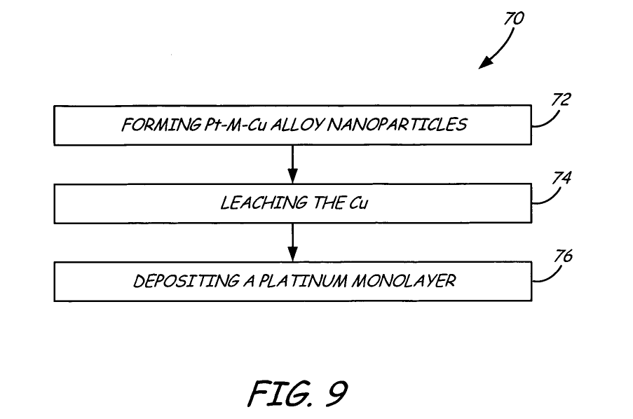

As described above, catalytic nanoparticles 30 of FIG. 2 can also be formed from platinum-noble metal-copper (Pt-M-Cu) alloy nanoparticles. FIG. 9 is a block diagram of method 70 for forming porous platinum-noble metal alloy cores with a platinum layer shell. Method 70 includes forming Pt-M-Cu alloy nanoparticles (step 72), leaching the copper (step 74), and depositing a platinum monolayer (step 76). In step 72, Pt-M-Cu alloy nanoparticles are formed, where M represents a noble metal selected from gold, palladium, iridium, rhodium, rhenium, ruthenium and osmium. Pt-M-Cu nanoparticles can be formed with a method similar to that described above for Pd—Cu alloy nanoparticles in step 42. For example, a copper salt can be added to Pt-M alloy nanoparticles and heat dried to form Pt-M-Cu alloy nanoparticles. In one example, the carbon supported PtPd₄ nanoparticles are mixed with a CuSO₄ solution and dried. The nanoparticles should be dried at a sufficiently high temperature to ensure formation of a high degree alloy. In one example, the nanoparticles are dried at about 400 degrees Celsius to about 1000 degrees Celsius.

The platinum to noble metal M ratio can be adjusted so that the alloy contains a small amount of platinum compared to the noble metal M in order to reduce the material costs. In one example, the platinum to noble metal M mole ratio is between about 1:2 to about 1:12. In another example, the platinum to noble metal M mole ratio is between about 1:3 and about 1:6.

The mole ratio of copper to platinum and noble metal (i.e. the mole ratio of non-noble metal to noble metal) is also controlled. In one example, the copper to platinum and noble metal mole ratio of the alloy nanoparticles is between about 1:1 to about 12:1. In another example, the atomic ratio of copper to platinum and noble metal is larger than about 2. In a further example, the copper to platinum and noble metal mole ratio is between about 4:1 and about 8:1.

The resulting Pt-M-Cu nanoparticles are solid nanoparticles having diameters, for example, between about 5 nm and about 50 nm. The lattice constant of the Pt-M-Cu alloy nanoparticles should be smaller than that of bulk platinum.

In step 74, copper is removed from the Pt-M-Cu alloy nanoparticles. Step 74 is similar to step 44 of FIG. 3. For example, copper can be removed by an acid solution or by an electrochemical process. The reaction conditions should be controlled to promote dissolution of copper while preventing the dissolution of platinum and the noble metal. For example, where the alloy nanoparticles are mixed in a nitric acid solution to dissolve the copper, the nitric acid concentration is maintained between about 1 M and about 8 M and the temperature is maintained between about 20 degrees Celsius and about 80 degrees Celsius depending on the composition of the nanoparticles.

Removing copper from the alloy nanoparticles creates porous core 32 of FIG. 2, where core 32 is formed from a Pt-M alloy. Pores are created by the voids left by the removed copper atoms and the diffusion of the noble metal atoms. In one example, the pores are between about 0.5 nm and about 5.0 nm. In another example, the pores are between about 0.5 nm and about 1.0 nm. The size of the pores can be adjusted by changing the mole ratio of copper to platinum and noble metal M in the Pt-M-Cu alloy nanoparticles.

It should be noted that trace amounts of copper may not be leached from the alloy nanoparticles. In this case, porous core 32 contains a Pt-M-Cu alloy. As discussed above, the presence of this trace amount of copper will not significantly affect the performance of the fuel cell because the copper will also be difficult to leach out during the potential cycling process of a fuel cell.

In step 76, a platinum monolayer is deposited. Step 76 can include depositing a layer of copper by underpotential deposition and displacing the copper with platinum, as described above with respect to step 46 of FIG. 3. Depositing a platinum monolayer on the porous core creates catalytic nanoparticles 30 of FIG. 2. Additional layers of platinum can be deposited in the core by repeating step 76.

In method 70, Pt-M-Cu alloy nanoparticles are used to form porous core 32. As described above, using alloy nanoparticles as the starting material for porous core 32 results in core 32 having an altered lattice constant and electronic structure. The Pt:M ratio and noble metal M can be adjusted to change the structural and electronic effects of core 32. Catalytic nanoparticles 30 formed by method 70 have benefits similar to those described above for catalytic nanoparticles formed from palladium alloy nanoparticles.

Although the alloy nanoparticles described above in methods 40, 50, 60 and 70 were described as containing copper, one skilled in the art will recognize that the alloy nanoparticles can be formed with a different non-noble metal. For example, the copper of the starting alloy nanoparticle can be replaced with nickel. The non-noble metal should have a lattice constant less than the lattice constant of platinum in order to achieve the structure effects described above.

The present invention is more particularly described in the following examples that are intended as illustration only, since numerous modifications and variations within the scope of the present invention will be apparent to those skilled in the art.

### Example

Palladium-copper alloy nanoparticles were formed by ultrasonically dispersing 2 grams of 20% Pd/C in 100 ml of water. 5 grams of Cu(NO₃)₂.5H₂O was added into the suspension to form a mixture. The mixture was dried in a vacuum oven at 80° C. The dried powder was heated to 250° C. and held for 60 minutes. Then the temperature was increased to 700° C. and held for two hours. The palladium-copper alloy nanoparticle powder was allowed to cool and was collected.

Next, the copper was leached from the palladium-copper alloy nanoparticles of the powder to create porous palladium cores. 1 gram of the palladium-copper alloy nanoparticle powder was cast on a carbon paper with a loading of 0.2 mg Pd/cm². The electrode was placed in an electrochemical cell with solution consisting of 0.1 M HClO₄ saturated with argon, and copper from the alloy nanoparticles was dissolved by potential cycling in the potential range of 0.02-1.2 V (vs. RHE) at room temperature for 50 cycles to create porous palladium cores.

Then the porous palladium cores were placed in an electrochemical cell with a solution consisting of 0.05 M CuSO₄+0.05 M H₂SO₄+1 M K₂SO₄ saturated with argon. The potential was controlled at 0.1 V (vs. Ag/AgCl, 3M) for 5 minutes and copper atoms deposited on the surface of the porous palladium cores. 200 ml of 2 mM PtK₂Cl₄+0.05 M H₂SO₄ saturated with argon was quickly added into the cell without potential control. The reaction was kept for 30 minutes to ensure all the copper atoms were displaced with platinum atoms. The final products were collected by washing with water and drying in an oven.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A catalytic nanoparticle comprising:
a porous palladium, palladium-M or platinum-M core, where M is selected from the group consisting of gold, iridium, osmium, palladium, rhenium, rhodium and ruthenium; and
an atomically thin layer of platinum atoms on the core.

2. The catalytic nanoparticle of claim 1, wherein the porous core is formed from an alloy nanoparticle having a non-noble metal to noble metal mole ratio of about 1:1 to about 1:12.

3. The catalytic nanoparticle of claim 1, wherein the catalytic nanoparticle has a diameter between about 2 nanometers and about 50 nanometers.

4. The catalytic nanoparticle of claim 1, wherein the porous core has pores between about 0.5 nm and about 5 nm.

5. The catalytic nanoparticle of claim 1, wherein the porous core further comprises a transition metal.

6. The catalytic nanoparticle of claim 5, wherein the transition metal is selected from the group consisting of cobalt, nickel, iron chrome, zinc and molybdenum.

7. The catalytic nanoparticle of claim 1, wherein the atomically thin layer is selected from the group consisting of a monolayer, a bilayer and a trilayer of platinum metal atoms.

8. The catalytic nanoparticle of claim 1, wherein the porous core includes platinum and palladium and has a platinum to palladium mole ratio of about 1:2 to about 1:12.

9. The catalytic nanoparticle of claim 8, wherein the platinum to palladium mole ratio is about 1:3 to about 1:6.

10. A method for forming a catalytic structure, the method comprising:
forming an alloy nanoparticle comprising palladium and a non-noble metal or platinum and a non-noble metal;
leaching the non-noble metal from the alloy nanoparticle to form a porous core; and
depositing a platinum monolayer on the porous core.

11. The method of claim 10, wherein the alloy nanoparticle comprises palladium and the non-noble metal is copper.

12. The method of claim 11, wherein the step of forming the alloy nanoparticle comprises:
forming the alloy nanoparticle having a copper:palladium mole ratio between about 1:1 and about 12:1.

13. The method of claim 12, wherein the step of forming the alloy nanoparticle comprises:
forming the alloy nanoparticle having a copper:palladium mole ratio between about 4:1 and about 8:1.

14. The method of claim 10, wherein the step of leaching creates the porous core having pores between about 0.5 nm and about 5 nm in diameter.

15. The method of claim 10, wherein the step of forming the alloy nanoparticle comprises:
forming the alloy nanoparticle comprising palladium, copper and a transition metal.

16. The method of claim 15, wherein the transition metal is selected from the group consisting of cobalt and nickel.

17. The method of claim 15, wherein the alloy nanoparticle has a palladium to copper and transition metal mole ratio between about 1:1 and about 1:12.

18. The method of claim 11, wherein the step of depositing a platinum monolayer comprises:
depositing a copper monolayer on the porous core; and
replacing the copper monolayer with the platinum monolayer.

19. The method of claim 10, wherein the step of forming the alloy nanoparticle comprises:
forming the alloy nanoparticle comprising platinum, palladium and copper and having a platinum:palladium mole ratio of between about 1:2 and about 1:12.

20. The method of claim 10, wherein the alloy nanoparticle has a palladium to copper mole ratio of between about 1:1 and about 1:12.
